(19) United States
(12) Patent Application Publication
(10) Pub. No.: US 2014/0240234 A1
(43) Pub. Date: Aug. 28, 2014

(54) Input Device

(71) Applicant: HEWLETT-PACKARD DEVELOPMENT COMPANY, L.P., Houston, TX (US)

(72) Inventor: Raija Bylander, Stockholm - Solna (SE)

(73) Assignee: Hewlett-Packard Development Company, L.P., Houston, TX (US)

(21) Appl. No.: 13/779,953

(22) Filed: Feb. 28, 2013

(51) Int. Cl. G06F 3/02

(52) U.S. Cl. CPC G06F 3/02
USPC 345/168; 345/156

(57) ABSTRACT

An example method for inputting data into a device in accordance with aspects of the present disclosure includes detecting, by a sensor, an object in an area on an input device, generating input device data indicating a function responsive to the detected object, and providing the input device data to an output device. The output device displays a digital input device in response to receiving the input device data, and the digital input device has a specified area corresponding to the area on the input device.

### BACKGROUND

Electronic devices, including personal computers and mobile phones, may have keyboards for receiving input from a user. Keyboards are typically used to type text and numbers into a word processor, text editor or other programs. Keyboards may also be used for computer gaming, either with regular keyboards or by using keyboards with special gaming features, which can expedite frequently used keystroke combinations.

Keyboards can include an arrangement of buttons or keys and operate using mechanical switching devices. Keyboards have characters engraved or printed on the keys, and the user enters information into the computer by pressing the keys on a keyboard. Each press of a key corresponds to a single written symbol and can produce actions or computer commands.

### BRIEF DESCRIPTION OF THE DRAWINGS

Example implementations are described in the following detailed description and in reference to the drawings, in which:

FIG. 1 illustrates an example system in accordance with an implementation;

FIG. 2 illustrates example components of an example system in accordance with an implementation; and

FIG. 3 illustrates an example process flow diagram in accordance with an implementation.

### DETAILED DESCRIPTION

Various implementations described herein are directed to an interface device that incorporates sensors. More specifically, and as described in greater detail below, various aspects of the present disclosure are directed to a manner by which a sensor in a keyboard detects object presence on certain keys of the keyboard.

Aspects of the present disclosure described herein render an image of the keyboard in response to detecting an object on the keys or keyboard and highlight the keys that the object is on. This object may be the fingers of a user. While pressing the keys on a keyboard, most users look down at the keyboard to select the correct keys to press. Moreover, most users look down at the keyboard to correct a typographic error they may have made by pressing the wrong key. According to various aspects of the present disclosure, the approach described herein allows a user to see which keys the user's fingers are on without looking down at the keyboard. Moreover, aspects of the present disclosure described herein also render a magnified image of the keys that the user presses on. Among other things, this approach may prevent the user having to look down at the keyboard to see what keys the user's fingers have pressed, and accordingly, limit typing errors, increase typing speed and lead to less neck pains and eye strains.

In one example in accordance with the present disclosure, a method for inputting data into a device is provided. The method comprises detecting, by a sensor, an object in an area on an input device, generating input device data indicating a function responsive to the detected object, and providing the input device data to an output device. The output device displays a digital input device in response to receiving the input device data, and the digital input device has a specified area corresponding to the area of the input device.

In another example in accordance with the present disclosure, a non-transitory computer-readable medium is provided. The non-transitory computer-readable medium comprises instructions that when executed cause a device to (i) detect an object in an area on an input device, and (ii) provide input device data to an output device to indicate a function responsive to the detected object. In accordance with this example, the output device displays a digital input device in response to receiving the input device data, and the digital input device has a specified area corresponding to the area on the input device.

In a further example in accordance with the present disclosure, a system is provided. The system comprises a sensor detecting an object in an area on an input device, and a controller, coupled to the sensor, providing input device data to an output device, the input device data generated in response to the detected object and indicating a function responsive to the detected object. In accordance with this example, the output device displays a digital input device in response to receiving the input device data, and the digital input device has a specified area corresponding to the area on the input device.

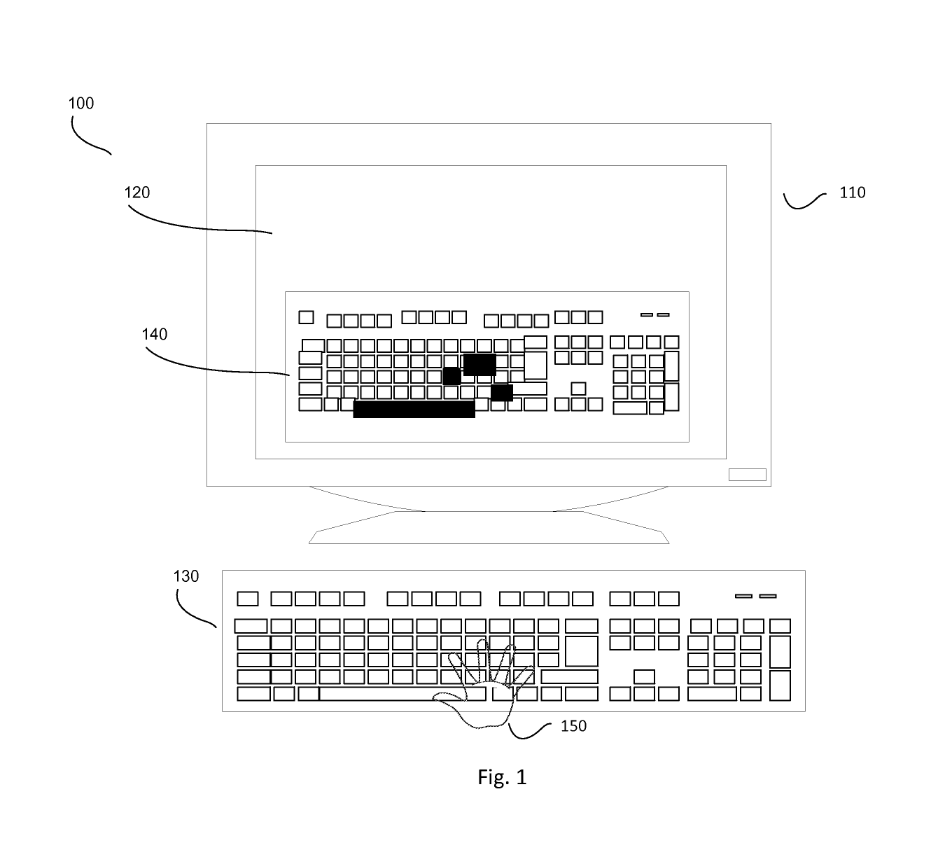

FIG. 1 illustrates an example system 100 in accordance with an implementation. The system 100 comprises a computer 110 with a user interface 120, a keyboard 130, each of which is described in greater detail below. It should be readily apparent that the system 100 depicted in FIG. 1 represents a generalized illustration and that other components may be added or existing components may be removed, modified, or rearranged without departing from a scope of the present disclosure. For example, while the system 100 illustrated in FIG. 1 includes only one user interface 120, the system may actually comprise a plurality of user interfaces, and only one has been shown and described for simplicity.

The computer 110 may be a user device. It should be noted that the computer 110 is intended to be representative of a broad category of data processors. The computer 110 may include a processor and memory and help translate input received by the keyboard 130. In one implementation, the computer 110 may include any type of processor, memory or display. Additionally, the elements of the computer 110 may communicate via a bus, network or other wired or wireless interconnection.

As non-limiting examples, the computer 110 may be configured as any type of personal computer, portable computer, workstation, personal digital assistant, video game player, communication device (including wireless phones and messaging devices), media device, including recorders and players (including televisions, cable boxes, music players, and video players) or other device capable of accepting input from a user and of processing information. Alternatively or in addition, the computer 110 may be a data input or output device, such as a remote control or display device, that may communicate with a computer or media system (e.g., remote control for television) using a suitable wired or wireless technique.

In some implementations, a user 150 may interact with the system 100 by controlling the keyboard 130, which may be an input device for the computer 110. The user may perform various gestures on the keyboard 130. Such gestures may involve, but not limited to, touching, pressing, waiving, placing an object in proximity.

In one implementation, the user interface 120 may be a display of the computer 110. The user interface 120 may refer to the graphical, textual and auditory information a computer program may present to the user 150, and the control sequences (such as keystrokes with the computer keyboard) the user 150 may employ to control the program. In one example system, the user interface 120 may present various pages that represent applications available to the user 150. The user interface 120 may facilitate interactions between the user 150 and computer systems by inviting and responding to user input and translating tasks and results to a language or image that the user 150 can understand. In another embodiment, the computer 110 may receive input from a plurality of input devices, such as a keyboard, mouse, touch device or verbal command.

The keyboard 130 may be arranged as a QWERTY keyboard and may require activation (e.g., pressing) of an individual key to produce a data character or function, or the simultaneous activation of two or more keys to produce a secondary data character or function. The keyboard 130 may have keys which can be moved downward by pushing down on the touch surface of each key in order to indicate that the user intends to enter the character represented by the key. In one implementation, the keyboard 130 may be a component of an interface device allowing a user to interact with a computer, a telephone system, or other electronic information system. An interface device may include some form or forms of output interface, such as a display screen or audio signals, and some form or forms of input interface, such as buttons to push, a keyboard (e.g., the keyboard 130), a voice receiver, or a handwriting tablet.

The keyboard 130 may include at least one sensor. The sensors may be capable of detecting the interaction of the user 150 caused by touch and actuation of key switches. The sensors may detect any objects, which may include, but not limited to, a stylus, fingers of a user, and/or other input object on the keyboard 130. In response to the detection, a digitally displayed keyboard 140 (e.g., digital keyboard) may pop up on the user interface 120 having varying degrees of transparency. In one implementation, the digitally displayed keyboard 140 is an image of the keyboard 130 displayed on the user interface 120. Alternatively or in addition, the specific keys on which the stylus, fingers of a user, or other input object(s) are detected may be specified. For example, the keys may be highlighted in a different color on the user interface 120. In one implementation, the digitally displayed keyboard 140 may be overlaid on a sequence of already existing images on the user interface 120. In one implementation, the digitally displayed keyboard 140 may be at least partially transparent. In another implementation, the digitally displayed keyboard may be opaque, covering a portion of the screen. For example, the digitally displayed keyboard may be shown on a corner of the user interface 120 in a solid rectangle box.

In one implementation, the digitally displayed keyboard 140 may be an a virtual keyboard, which may show a virtual key input, compatible with a display such as a touch screen, and may directly receive the key value of a position touched through the screen.

In another implementation, the digitally displayed keyboard 140 may be linked to a spell checker. Accordingly, the digitally displayed keyboard 140 may alert the user of any typographical errors identified based on the key the user chooses to press. Such alert may include, but not limited to, a message informing the user that may have pressed an incorrect key.

In another implementation, the user 150 may choose to press at least one key on the keyboard 130. In response to detected pressing, the key that is actuated (e.g., pressed) may be specified on the digitally displayed keyboard 140. For example, the visual indication of the pressed key may be magnified on the user interface 120. In one implementation, an optical keyboard technology utilizing light emitting devices and photo sensors may be used to optically detect actuated keys.

In a further implementation, the keyboard 130 may include control circuitry to convert key presses into key codes (e.g., scan codes) and send the codes down a serial cable (e.g., a keyboard cord) to the computer 110.

Depending on the implementation, security features/tools may be implemented in various ways such as by a firewall, one time passwords, encryption programs, digital certificates, user application security, etc. Various combinations of these and/or other security features may be used. In one implementation, these security approaches may be layered to provide a highly secure environment in which a user can interact with the user interface 120 and/or the digitally displayed keyboard 140. For example, the security features may require a user to log in before activating the sensors in the keyboard 130 or displaying the digitally displayed keyboard 140. In other implementations, the security features may require the user to log in in order to determine whether the user has permission to set or edit the settings associated with the digitally displayed keyboard 140 (e.g., location on the user interface 120, size, color, layout, etc.).

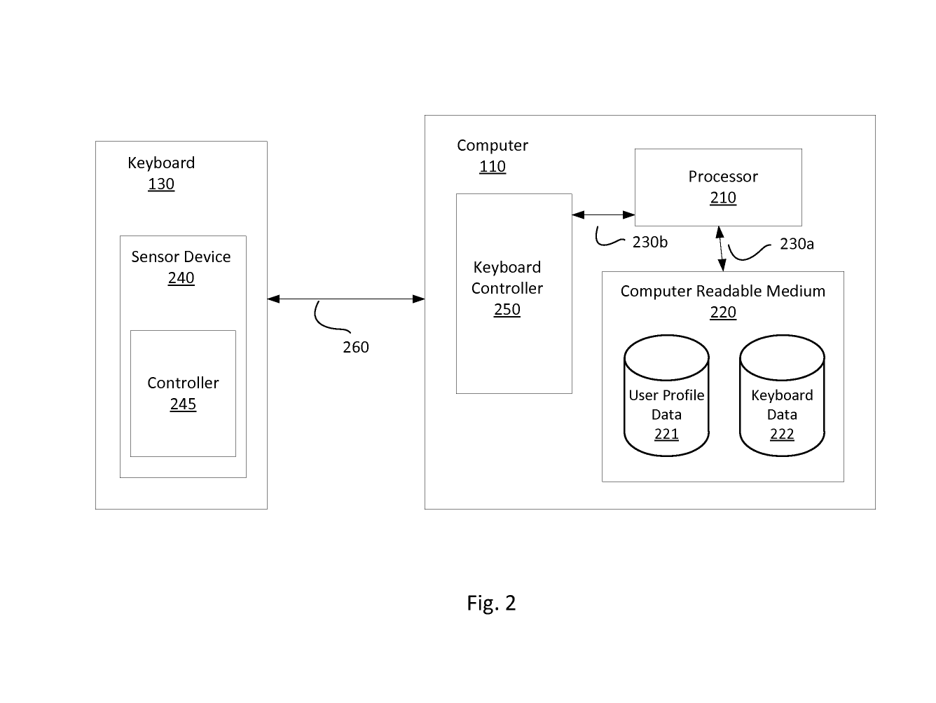

FIG. 2 illustrates example components of the system 100 in accordance with an implementation. It should be readily apparent that the computer 110 illustrated in FIG. 2 represents a generalized depiction and that other components may be added or existing components may be removed, modified, or rearranged without departing from a scope of the present disclosure. The computer 110 comprises a processor 210, a computer readable medium 220, a keyboard controller 250, each of which is described in greater detail below. The components of the computer 110 may be connected via buses. For example, the processor 210 and the computer readable medium 220 may be connected via a bus 230a, and the processor 210 and the keyboard controller 250 may be connected via a bus 230b. The computer readable medium 220 may comprise various databases containing, for example, user profile data 221 and keyboard data 222.

The processor 210 may retrieve and execute instructions stored in the computer readable medium 220. The processor 210 may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium, or a combination thereof. The processor 210 may fetch, decode, and execute instructions stored on the storage medium 220 to operate the computer 110 in accordance with the above-described examples. The computer readable medium 220 may be a non-transitory computer-readable medium that stores machine readable instructions, codes, data, and/or other information.

In certain implementations, the computer readable medium 220 may be integrated with the processor 210, while in other implementations, the computer readable medium 220 and the processor 210 may be discrete units.

Further, the computer readable medium 220 may participate in providing instructions to the processor 210 for execution. The computer readable medium 220 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices.

In one implementation, the computer readable medium 220 may have a user profile database. The user database may store user profile data 221 such as user authentication data, user interface data, and profile management data and/or the like. In one implementation, user authentication data may comprise (i) group membership information (e.g., finance, management), (ii) authorization information (e.g., unauthorized, authorized, forbid/blocked, guest, or quarantined), and/or (iii) security keys (e.g., 1a2b3c4d).

In another implementation, the computer readable medium 220 may have a keyboard database. The keyboard database may store keyboard data 222 such as location, size, color, shape, layout and/or the like. In another implementation, to create a high level of security, packet filter access can be installed between databases. Consistent with the present disclosure, the databases could be maintained as a single database.

The processor 210 may comprise at least one high-speed data processor adequate to execute program components for executing user and/or system-generated requests. In one implementation, the processor 210 may include a software module that processes the key strokes captured from the keyboard 130. This module may also be used to respond to the detection of any objects present on the keys of the keyboard 130 captured by a sensor device 240. Moreover, the processor 210 may also include a software module that generates a digitally displayed keyboard (e.g., the digitally displayed keyboard 140, as illustrated in FIG. 1). Alternatively or in addition, the processor 210 may provide a way for a user to interact with the digitally displayed keyboard by highlighting specific keys based on the detection of the objects on those specific keys.

The keyboard controller 250 may serve as an interface between the keyboard 130 and the computer 110. The keyboard controller 250 may include a processing device that may be adapted to receive data from the keyboard 130 and/or an input device, process the data, and pass the processed data to the processor 210. Such process data may comprise input device data indicating functions responsive to the detected objects. In one implementation, the processed data may be in the form of numeric data called scan codes. In one implementation, the keyboard controller 250 may be implemented in the computer 110. In another implementation, the keyboard controller 250 may be a stand-alone device. In a further implementation, the keyboard controller 250 may be implemented in the keyboard 130. Furthermore, in some implementations, the keyboard controller 250 may be implemented using embedded controllers that may run specialized keyboard controller software. In other implementations, the keyboard controller 250 may be implemented using multifunction I/O devices, such as a “Super I/O” device.

In a further implementation, the keyboard controller 250 may receive data from pointing devices, such as computer mice, trackballs or touch pads. The keyboard controller 250 may process the data from such devices, and output the processed data in a form that may represent position or motion.

The keyboard controller 250 may comprise all or part of one or more integrated circuits, firmware code, and/or software code that may receive electrical signals from the sensor device 240 and communicate with the computer 110. In one implementation, the keyboard controller 250 may be located with or near the sensor device 240. In other embodiments, some elements of the keyboard controller 250 may be with the sensor device 240 and other elements of the keyboard controller 250 may reside in the computer 110.

The keyboard 130 may comprise the sensor device 240 and a sensor controller 245. Moreover, the keyboard 130 may have a processor, a switch and other components that may be added, removed, modified, or rearranged without departing from a scope of the present disclosure. It should be readily apparent that while the keyboard 130 illustrated in FIG. 2 includes only one sensor device 240, the system may actually comprise a plurality of sensor devices, and only one has been shown and described for simplicity.

In one implementation, the keyboard 130 may be any information conveying device which includes a sensor device located on one of the keys (e.g., the J key) of the keyboard 130 of the computer 110. In another implementation, the keyboard 130 may include a sensor array, which may act as a group of sensors deployed in certain geometry pattern. The sensor array may be configured to fit within the area of the touch surface of a key on the keyboard 130. In a further implementation, a sensor array could be housed in a separate part, rather than being mounted in a keyboard key.

The sensor device 240 may include a controller 245. In one implementation, the sensor device 240 may be coupled to the computer 110 through the keyboard controller 250 via a bus 260 of the computer 110. In another implementation, the sensor device 240 can be connected to the computer 110 through any type of interface or connection, including 12C, SPI, PS/2, Universal Serial Bus (USB), Bluetooth, RF, IRDA, keyboard scan lines or any other type of wired or wireless connection to list several non-limiting examples.

The sensor device 240 may use a variety of techniques for detecting the presence of an object. In one implementation, the sensor device 240 may include electrodes or other structures that are adapted to detect object presence, and the sensor device 240 may include touch sensors. The touch sensors may be based on technologies such as touch capacitance, infrared red, surface-acoustic way, resistive, or optical sensors.

In one implementation, the sensor device 240 may be used to detect a stylus, finger or other input object(s). Accordingly, the sensor device 240 may be sensitive to the position of one or more input objects, such as a stylus, finger and/or other input object placed on the keys of the keyboard 130. Using the controller 245, the sensor device 240 may provide indicia (including keyboard information) of the detected object to the computer 110. The computer 110 may process the indicia to generate the appropriate response (e.g., highlight certain keys on the digitally displayed keyboard 140, as illustrated in FIG. 1), as will be discussed in greater detail below. In another implementation, the sensors may be placed under the keys of the keyboard 130, and the sensor may be able to detect a position or motion of the object on the space above of the keys.

In one implementation, the sensor device 240 may provide input to the processor 210. The sensor device 240 may notify the processor 210 of contact events when a surface (e.g., a key) is touched. In one embodiment, the sensor device 240 may include the controller 245 that interprets raw signals produced by the sensor device 240 and communicates the information to the processor 210, using a known communication protocol via an available data port. In one implementation, the controller 245 may output the keyboard information to the keyboard controller 250 through a keyboard port.

As discussed in more detail above, the processor 210 may be in data communication with the computer readable medium 220, which may include a combination of temporary and/or permanent storage. The computer readable medium 220 may include program memory that includes all programs and software such as an operating system, user detection software component, and any other application software programs. The computer readable medium 220 may also include data memory that may include system settings, a record of user options and preferences, and any other data required by any element of the computer 110.

In another implementation, key switches may be used to detect key presses on the keyboard 130 from the user 150. The key switches may be based on switch technology.

As discussed above, the sensor device 240 may output keyboard information responsive to the detected object presence. In another illustration, the sensor device 240 may output object positional information in response to the detected object presence.

Alternatively or in addition, in one embodiment, the contact between an object and the surface of a key on the keyboard 130 may be required, either with or without applied pressure. In other implementations, no contact may be required to operate. The distance between the object and the surface of the key may be on the order of less than a millimeter, millimeters, centimeters, or more, and may vary significantly with the type of sensing technology used and the accuracy desired.

In the implementation, where no contact between the object and the surface of the key is required, capacitive sensing may be used. Capacitive touch sensing may allow high-precision tracking of a user's finger motion with no electrical contact between user and device. Capacitive sensors may be added to the surface of each key. The sensors may be made from very thin (e.g., 0.8 mm) printed circuit boards routed to the shape of each key. Each key records the position of fingers on the surface. The sensor device 240 may use technologies such as touch capacitance, infrared red, surface-acoustic way, Hall-effect, or optical sensors.

In another implementation, the keyboard may detect vibrations caused by user interaction via vibration sensors. The vibration sensors may be based on technologies such as accelerometers and piezo-acoustic sensors.

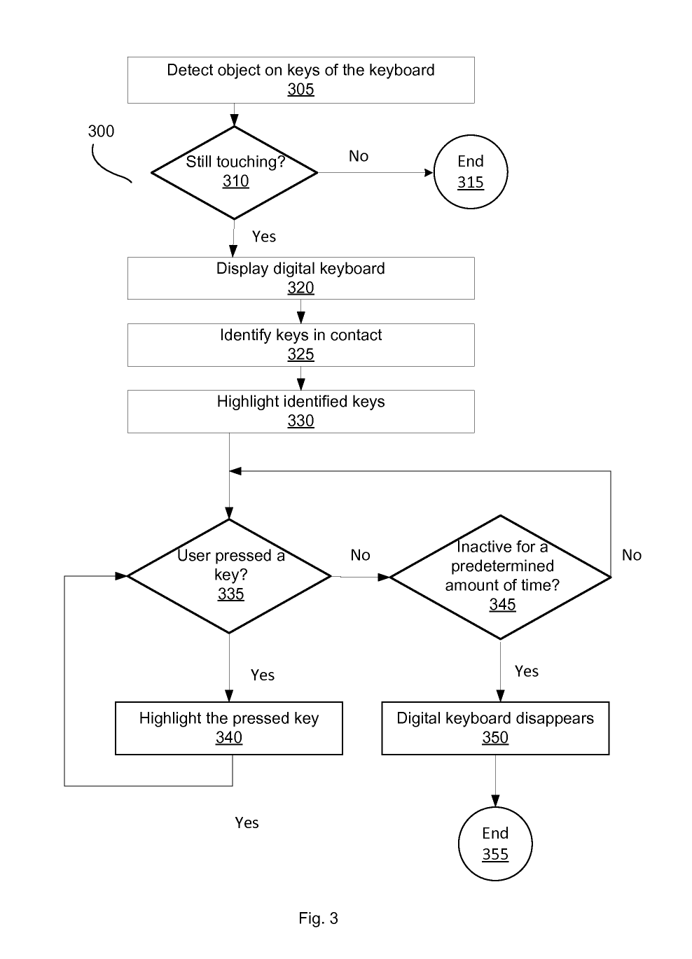

Turning now to the operation of the system 100, FIG. 3 illustrates an example process flow diagram 300 in accordance with an implementation. It should be readily apparent that the processes illustrated in FIG. 3 represents generalized illustrations, and that other processes may be added or existing processes may be removed, modified, or rearranged without departing from the scope and spirit of the present disclosure. Further, it should be understood that the processes may represent executable instructions stored on memory that may cause a processor to respond, to perform actions, to change states, and/or to make decisions. Thus, the described processes may be implemented as executable instructions and/or operations provided by a memory associated with a system 100. Alternatively or in addition, the processes may represent functions and/or actions performed by functionally equivalent circuits like an analog circuit, a digital signal processor circuit, an application specific integrated circuit (ASIC), or other logic devices associated with the system 100. Furthermore, FIG. 3 is not intended to limit the implementation of the described implementations, but rather the figure illustrates functional information one skilled in the art could use to design/fabricate circuits, generate software, or use a combination of hardware and software to perform the illustrated processes.

The process 300 may begin at block 305, where the sensor detects the presence of an object on the keyboard (e.g., a touch action to at least one key of the keyboard). As discussed in more detail above with respect to FIG. 2, an object may be a user's fingers, a stylus or any other object that may be configured to create contact with the surface of the keys on a keyboard. The user may be, e.g., a person such as an administrator of a computer and/or an automated machine capable of touching physical objects. In particular, the detection process may involve, for example, detecting an interruption of the infrared light being reflected from a light source in the keyboard when the user's fingers are placed on to the surface of the keys on the keyboard.

At block 310, the system proceeds to determine whether the presence of the object on the keyboard is for the purpose of interacting with the system 100. In particular, this process may involve verifying that, for example, the contact between the fingers of the user and the keys on the keyboard is maintained for a predetermined period of time (e.g., 2 seconds). In the event that no object is detected on the keys after the predetermined period of time (e.g., the object was placed on the keyboard by mistake), at block 315, the process ends.

In the event that the sensed objects are found to be present after the predetermined period of time, at block 320, the system renders a digital image of the keyboard on the user interface. This digitally displayed keyboard on the user interface may have the same key layout as the keyboard (e.g., physical keyboard).

At block 325, the system identifies the keys that the object is in contact with (e.g., the keys that the user fingers are placed on). As part of the process of identification of the keys, the keyboard controller may generate an output in the form of keyboard information. In one implementation, such keyboard information may be simulated keyboard data. In another implementation, the keyboard information may be implemented based on the identified keys as scan codes that identify one or more functions on the computer that the keyboard is connected to. Thus, this process may further involve the keyboard controller receiving the keyboard information and initiating the function identified by the scan code.

At block 330, the digitally displayed keyboard is rendered to specify the keys that the user's fingers are touching. In particular, this process involves the computer receiving the keyboard information, which may include the list of the identified keys. The process of specifying the keys may further include highlighting the identified keys on the digitally displayed keyboard. Accordingly, in one example, the user can view the keys that his fingers are touching on the user interface without having to look down at the keyboard or his hands.

At block 335, after highlighting the particular keys, the system checks whether the user proceeds to press any of the keys on the keyboard. In one implementation, the user may choose to press one of the keys that his fingers are touching. In another implementation, the user may use to move his finger(s) to touch another key and press that key. In the event that a key is found to be pressed, at block 340, the pressed key is specified (e.g., highlighted) on the digitally displayed keyboard. Accordingly, in one example, the user may view the keys he is pressing on the user interface without having to look down at the keyboard or his hands. In the event that no key is found to be pressed, at block 345, the system determines whether the object(s) touching the key(s) on the keyboard performed any actions within a predetermined period of time (e.g., 5 minutes). In one implementation, the actions may include, but not limited to, moving from one key to another, pressing a key, retouching the same key, etc.

If no change in the position of the object on the keyboard has been detected for over a set period of time (e.g., the user has not moved his hands for 5 minutes), at block 350, the digitally displayed keyboard disappears (e.g., fades away), and at block 355, the process ends. If a change in the position of the object has been detected and/or the predetermined period of time has not lapsed, the system proceeds to check whether the user has pressed any keys (e.g., block 335), and continues as described above. In one implementation, the system may automatically detect when a key is pressed and proceeds to specify the pressed key (e.g., magnify the image of the key on the user interface).

In certain implementations, the system may cause the digitally displayed keyboard to disappear when the object is removed from the surface of the keys on the keyboard. Alternatively or in addition, the computer may cause the digitally displayed keyboard to disappear when the user logs out, or the digital keyboard display feature of the system 100 is turned off.

The present disclosure has been shown and described with reference to the foregoing exemplary implementations. It is to be understood, however, that other forms, details, and examples may be made without departing from the spirit and scope of the disclosure that is defined in the following claims. As such, all examples are deemed to be non-limiting throughout this disclosure.

What is claimed is:

1. A method for inputting data, comprising:
detecting, by a sensor, an object in an area on an input device;
generating input device data indicating a function responsive to the detected object; and
providing the input device data to an output device, wherein the output device displays a digital input device in response to receiving the generated input device data, the digital input device having a specified area corresponding to the area on the input device.

2. The method of claim 1, wherein the detected object comprises a finger of a user.

3. The method of claim 1,
wherein the input device is a keyboard comprising a plurality of keys, and the digital input device is a digital keyboard comprising a plurality of digital keys; and
wherein the area on the input device corresponds to a key on the keyboard, and the specified area on the digital input device corresponds to a digital key on the digital keyboard.

4. The method of claim 3, further comprising:
detecting an action on a key on the keyboard, and
specifying, on the digital keyboard, a digital key that corresponds to the key on the keyboard.

5. The method of claim 4,
wherein the action comprises touching, without pressing, a key on the keyboard; and
wherein specifying the digital key that corresponds to the key on the keyboard further comprises highlighting the digital key for the user to view the key being touched.

6. The method of claim 4,
wherein the action comprises pressing of a key on the keyboard; and
wherein specifying the digital key that corresponds to the key on the keyboard further comprises magnifying the digital key of the digital keyboard for the user to view the key being pressed.

7. The method of claim 3, wherein each key in the keyboard comprises a sensor responsive to at least touching and pressing.

8. The method of claim 1, wherein the digital input device is displayed over images on the output device, the digital input device being at least partially transparent.

9. The method of claim 1, wherein the digital input device is an opaque rectangular box occupying a portion of the output device.

10. The method of claim 1, wherein detecting, by the sensor, the detected object in the area on the input device further comprises confirming presence of the detected object in the area on the input device after a predetermined amount of time.

11. A non-transitory computer-readable medium comprising instructions that when executed cause a system to:
detect an object in an area on an input device; and
provide input device data to an output device to indicate a function responsive to the detected object, wherein the output device displays a digital input device in response to receiving the input device data, the digital input device having a specified area corresponding to the area on the input device.

12. The non-transitory computer-readable medium of claim 11, wherein the instructions further cause the input device to store the input device data.

13. The non-transitory computer-readable medium of claim 11, wherein the output device, in displaying the digital keyboard, is to adjust the digital keyboard based on settings associated with the digital input device.

14. The non-transitory computer-readable medium of claim 11, wherein the sensor, in detecting the object in the area on the input device, detects a touch between the detected object and the area on the input device.

15. The non-transitory computer-readable medium of claim 11, wherein the area on the input device has a sensor responsive to touching and pressing.

16. The non-transitory computer-readable medium of claim 15, wherein the sensor is an array of sensors positioned in the area on the input device.

17. The non-transitory computer-readable medium of claim 11, wherein the display of the digital input device is terminated if the detected object in the area on the input device is removed.

18. The non-transitory computer-readable medium of claim 11, wherein the output device displays an alert informing of an error in response to receiving the input device data.

19. An system, comprising:
a sensor to detect an object in an area on the input device; and
a controller, communicatively coupled to the sensor, to provide input device data to an output device, the input device data generated in response to a detected object and indicating a function responsive to the detected object,
wherein the output device is to display a digital input device in response to receiving the input device data, the digital input device having a specified area corresponding to the area on the input device.

20. The system of claim 19, further comprising a database to store information on the detected object and the area on the input device.
